(19) United States
(12) Patent Application Publication
(10) Pub. No.: US 2008/0268668 A1
(43) Pub. Date: Oct. 30, 2008

(54) CONNECTOR

(75) Inventors: Katsumi ARAI, Tokyo (JP); Seiya Matsuo, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Japan Aviation Electronics Industry, Limited, Tokyo (JP)

(21) Appl. No.: 12/061,912

(22) Filed: Apr. 3, 2008

(30) Foreign Application Priority Data
Apr. 27, 2007 (JP) 2007-119066

(51) Int. Cl. H01R 12/00

(52) U.S. Cl. 439/66

(57) ABSTRACT

A connector capable of positively bringing terminals of connected objects into contact with associated portions of conductive films. The conductive films are formed in a film, for electrically connecting pads of two objects to be connected which are arranged on opposite sides of an elastic body. The film on which the conductive films are formed are bonded to the elastic body. A slit is formed in each of contact portions of the conductive films which are brought into contact with the pads of the objects to be connected so as to divide each contact portion into a plurality of parts such that the parts are independently displaceable.

### BACKGROUND OF THE INVENTION

1. Field of the Invention

This invention relates to a connector, and more particularly to a connector which is interposed between two objects to be connected for connecting them to each other.

2. Description of the Related Art

Conventionally, there has been proposed an IC socket which includes a base plate, an elastic member, and a tab film, and is disposed on a printed circuit board (see Japanese Laid-Open Patent Publication (Kokai) No. 2003-297512 (Paragraph numbers [0017] to [0025], FIG. 5).

The base plate is a square plate, and has a large number of contact pins arranged on four sides thereof. The contact pins are inserted into through holes of a printed circuit board, for being electrically connected to the printed circuit board.

The elastic member has a plate-like shape, and is disposed in a central portion of the base plate. The elastic member is formed with slits in the form of a lattice. Elastic deformation portions are formed between the slits such that they are opposed to solder balls of an IC package, respectively.

The tab film has a deformable sheet-like shape, and is disposed on the elastic member. On one surface of the tab film, a plurality of contact points associated with the respective solder balls of the IC package are formed at equally spaced intervals. Formed on the other surface of the tab film are connection electrodes joined to the contact pins of the base plate. Further, tab film has conductor wires for connecting between the connection electrodes and the contact points. An IC package is mounted on the tab film.

The IC package mounted on the tab film is urged by an urging jig toward the tab film. As a result, the solder balls of the IC package are brought into contact with the contact points of the tab film, for being electrically connected to the printed circuit board via the contract points, the conductor wires, and the contact pins.

In the above-described IC socket, the individual elastic deformation portions of the elastic member are separately deformed even when there is variation in height of the solder balls of the IC package, which enables absorption of the variation in height of the solder balls. As a result, the contact points on the elastic deformation portions can be brought into contact with the solder balls substantially at a predetermined pressure. Moreover, since a plurality of contact points are used for one solder ball, it is possible to obtain more stable contact between the solder balls and the contact points.

However, for example, when a very small foreign matter is sandwiched between one of the plurality of contact points and a solder ball, this causes a problem that the other contact points cannot be brought into contact with the solder ball.

### SUMMARY OF THE INVENTION

The present invention has been made in view of these circumstances, and an object thereof is to provide a connector which is capable of positively bringing terminals of objects to be connected into contact with associated portions of conductive films.

To attain the above object, the present invention provides a connector comprising an elastic body, a conductive film formed on the elastic body, for electrically connecting respective terminals of two objects to be connected which are arranged on opposite sides of the elastic body, and a dividing portion for dividing a contact portion of the conductive film into a plurality of parts such that the parts are independently displaceable, the contact portion being brought into contact with an associated one of the terminals of the two objects to be connected.

With the arrangement of this connector, a dividing portion is employed which divides a contact portion of the conductive film into a plurality of parts such that the parts are independently displaceable, and hence even when a very small foreign matter is sandwiched between a terminal of one of the objects to be connected and part of the contact portion that is brought into contact with the terminal, the other part of the contact portion is brought into contact with the terminal.

According to the connector of the present invention, it is possible to positively bring the terminals of the objects to be connected into contact with associated portions of the conductive film.

Preferably, a film is disposed between the elastic body and the conductive film.

More preferably, a portion of the conductive film except for the contact portion brought into contact with the associated one of the terminals of the two objects to be connected is covered with a film.

More preferably, the dividing portion is a slit formed in the conductive film and the film.

More preferably, the dividing portion is a slit formed in the conductive film, the film, and the elastic body.

More preferably, the dividing portion is a cut formed in the conductive film and the film.

More preferably, the dividing portion is a cut formed in the conductive film, the film. and the elastic body.

Preferably, the conductive films are arranged at equally spaced intervals, and cutouts are formed in portions of the elastic body where the conductive films are not arranged.

The above and other objects, features and advantages of the present invention will become more apparent from the following detailed description taken in conjunction with the accompanying drawings.

### BRIEF DESCRIPTION OF THE DRAWINGS

FIG. 1 is a perspective view of a connector according to a first embodiment of the present invention;

FIG. 2 is a perspective view of a contact module of the FIG. 1 connector;

FIG. 3 is a perspective view of one end of the FIG. 2 contact module;

FIG. 4A is a conceptual view of the FIG. 3 contact module in a state before an IC package (IC package of a type with no resist) having foreign matter attached thereto is pressed against the contact module;

FIG. 4B is a conceptual view of the FIG. 3 contact module in a state in which the IC package having foreign matter attached thereto is pressed against the contact module;

FIG. 5A is a conceptual view of the FIG. 3 contact module in a state before a displaced IC package (IC package of a type with resist) is pressed thereagainst;

FIG. 5B is a conceptual view of the FIG. 3 contact module in a state in which the displaced IC package is pressed thereagainst;

FIG. 6 is a perspective view of a variation of the contact module according to the first embodiment;

FIG. 7 is a perspective view of one end of a contact module of a connector according to a second embodiment of the present invention;

FIG. 8A is a conceptual view of the FIG. 7 contact module in a state before an IC package (IC package of a type with no resist) having foreign matter attached thereto is pressed against the contact module;

FIG. 8B is a conceptual view of the FIG. 7 contact module in a state in which the IC package having foreign matter attached thereto is pressed against the contact module;

FIG. 9A is a conceptual view of the FIG. 7 contact module in a state before a displaced IC package (IC package of a type with resist) is pressed thereagainst;

FIG. 9B is a conceptual view of the FIG. 7 contact module in a state in which the displaced IC package is pressed thereagainst;

FIG. 10 is a cross-sectional view of a contact module of a connector according to a third embodiment of the present invention;

FIG. 11 is a perspective view of one end of the FIG. 10 contact module;

FIG. 12A is a conceptual view of the FIG. 11 contact module in a state before an IC package (IC package of a type with no resist) having foreign matter attached thereto is pressed against the contact module;

FIG. 12B is a conceptual view of the FIG. 11 contact module in a state in which the IC package having foreign matter attached thereto is pressed against the contact module;

FIG. 13A is a conceptual view of the FIG. 11 contact module in a state before a displaced IC package (IC package of a type with resist) is pressed thereagainst;

FIG. 13B is a conceptual view of the FIG. 11 contact module in a state in which the displaced IC package is pressed thereagainst;

FIG. 14 is a cross-sectional view of a contact module of a connector according to a fourth embodiment of the present invention;

FIG. 15 is a perspective view of one end of the FIG. 14 contact module;

FIG. 16A is a conceptual view of the FIG. 15 contact module in a state before an IC package (IC package of a type with no resist) having foreign matter attached thereto is pressed against the contact module;

FIG. 16B is a conceptual view of the FIG. 15 contact module in a state in which the IC package having foreign matter attached thereto is pressed against the contact module;

FIG. 17A is a conceptual view of the FIG. 15 contact module in a state before a displaced IC package (IC package of a type with resist) is connected to the contact module; and

FIG. 17B is a conceptual view of the FIG. 15 contact module in a state in which the displaced IC package is connected thereto.

### DETAILED DESCRIPTION OF THE PREFERRED EMBODIMENTS

The present invention will now be described in detail with reference to the drawings showing preferred embodiments thereof.

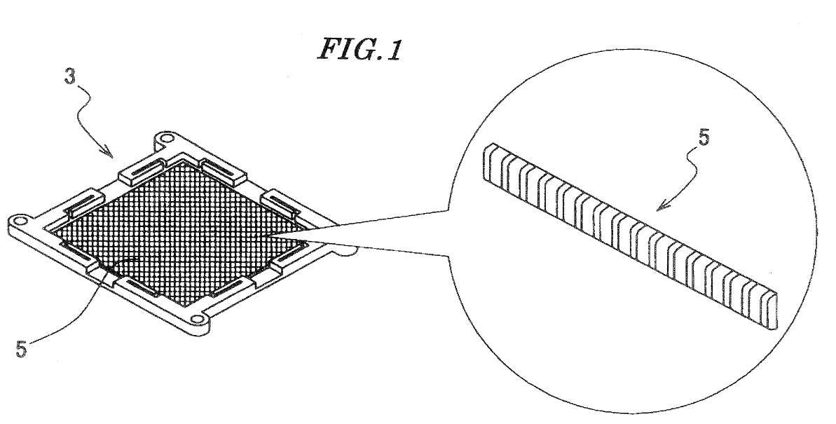

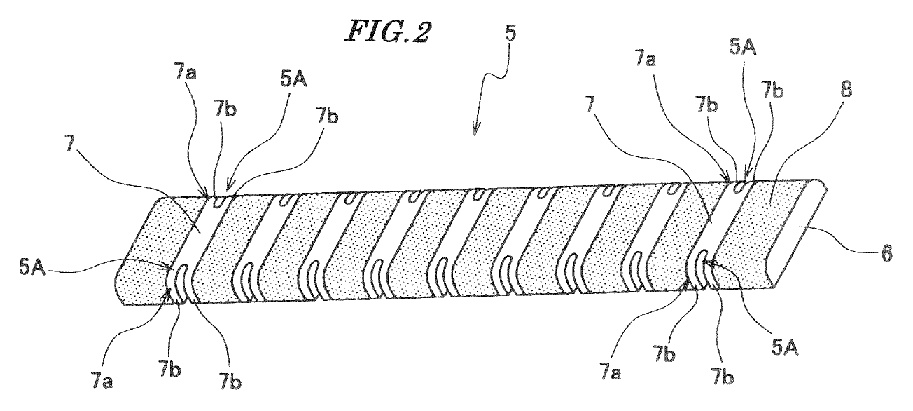

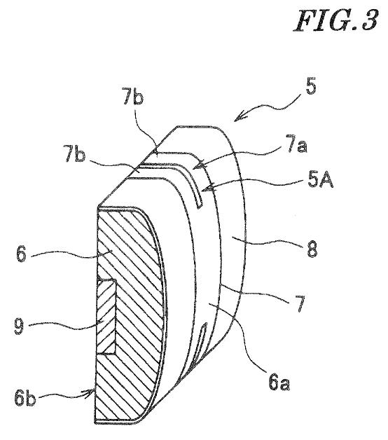

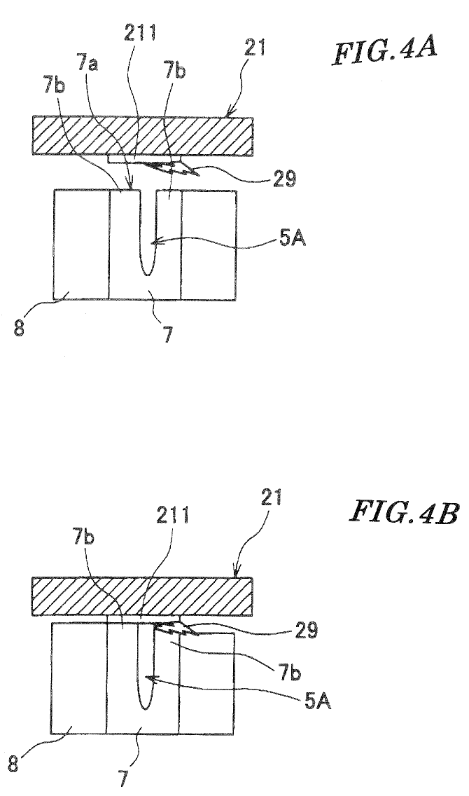

First, a connector according to a first embodiment of the present invention will be described with reference to FIGS. 1 to 6. Referring to FIGS. 1 to 3, the connector is comprised of a frame 3, and a plurality of contact modules 5, and electrically connects between an IC package (one object to be connected) 21 (see FIG. 4) and a printed circuit board (the other object to be connected), not shown.

The frame 3 holds the contact modules 5 which are two-dimensionally arranged. The upper end and the lower end of each contact module 5 held by the frame 3 protrude from the upper surface and the lower surface of the frame 3, respectively.

The contact module 5 includes an elastic body 6, a plurality of conductive films 7, and a film 8. The elastic body 6 in the form of a long plate is generally D-shaped in cross section. A material for the elastic body 6 may be suitably selected from elastomers, such as silicone rubber and silicone gel. The elastic body 6 has a reinforcing plate 9 embedded in a back surface 6b thereof.

The conductive films 7 each have a substantially belt-like shape in developed view, and are arranged at equally spaced intervals on a surface of the film 8. A gold-plated copper material or a gold-plated nickel material is suitable for a material for the conductive film 7.

The film 8 is bonded to a curved surface 6a formed on a front surface of the elastic body 6 such that the surface of the film 8 on which the conductive films 7 are formed faces outward.

In the state of the film 8 being bonded to the elastic body 6, the upper and lower ends of each conductive film 7 are positioned at the upper and lower ends of the elastic body 6, respectively. Therefore, the upper and lower ends of the conductive film 7 form portions 7a (portions brought into contact with terminals) which are brought into contact with pads (terminals of objects to be connected) of the IC package 21 and pads (terminals of objects to be connected) of the printed circuit board, not shown.

Each portion 7a which is brought into contact with an associated one of the pads is divided into two parts by a slit 5A such that the parts are independently displaceable, whereby the portion 7a is formed with two contact points 7b and 7b. The slit 5A is formed in the conductive film 7 and the elastic body 6.

When foreign matter 29, such as dust, is attached to one of pads 211 of the IC package 21, as shown in FIG. 4A, and the IC package 21 with the foreign matter 29 attached to the pad 211 thereof is pressed against the contact module 5, as shown in FIG. 4B, one of the two contact points 7b and 7b configured to be independently displaceable is largely pushed down by the foreign matter 29 attached to part of the pad 211, but the other contact point 7b is pushed down by the pad 211 substantially by a predetermined amount without being adversely affected by the motion of the one contact point 7b, for being brought into contact with the pad 211 substantially at a predetermined pressure. As a result, a state is ensured in which the conductive film 7 and the pad 211 are in stable contact with each other.

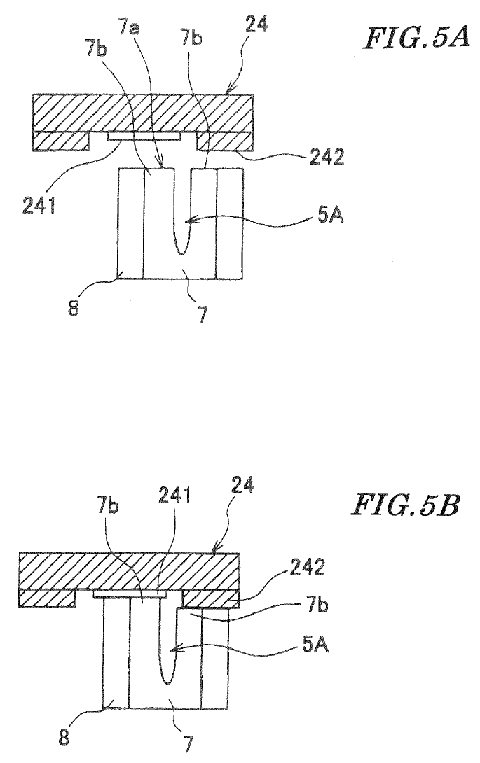

When an IC package 24 having resist 242 formed in the vicinity of a pad 241 thereof is not normally positioned, as shown in FIG. 5A, and the IC package 24 is pressed against the contact module 5 in the state in which the IC package 24 is not normally positioned, as shown in FIG. 5B, one of the two contact points 7b and 7b configured to be independently displaceable is brought into abutment with the resist 242 and is largely pushed down by the resist 242, but the other contact point 7b is pushed down by the pad 241 substantially by a predetermined amount without being adversely affected by the motion of the one contact point 7b, for being brought into contact with the pad 211 substantially at a predetermined pressure. As a result, a state is ensured in which the conductive film 7 and the pad 241 are in stable contact with each other.

As described above, according to the first embodiment, even if the very small foreign matter 29 is sandwiched between the pad 211 and the conductive film 7, or the IC package 24 is displaced relative to the conductive film 7, the contact points 7b and 7b and the pads 211 and 241 can be positively brought into contact with each other.

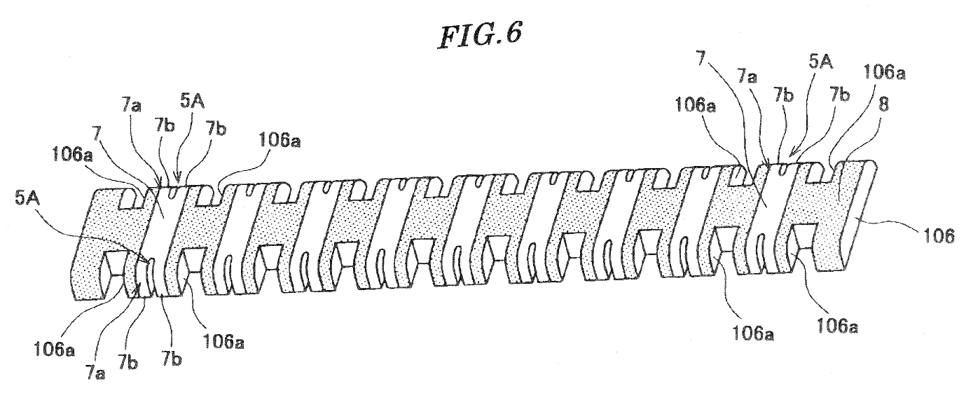

As shown in FIG. 6, as the elastic body, a variation of the present embodiment includes an elastic body 106 formed with cutouts 106a.

The cutouts 106a are formed in portions of the elastic body 106 where no conductive films 7 are arranged.

According to this variation, it is possible to obtain the same advantageous effects as provided by the first embodiment, and further enhance independence (independence in displacement or deformation) of the contact points 7b and 7b by the cutouts 106a.

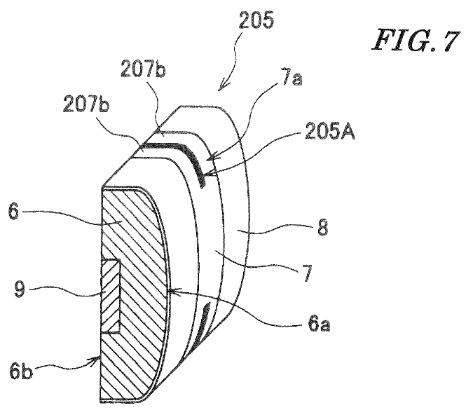

Now, a connector according to a second embodiment of the present invention will be described with reference to FIGS. 7 to 9B. Component parts identical to those of the connector according to the first embodiment are designated by identical reference numerals, and detailed description thereof is omitted, while only main component parts different in construction from those of the first embodiment will be described hereinafter.

Although in the first embodiment, each portion 7a of the contact module 5, which is brought into contact with an associated one of the pads of the IC package, is divided into two parts by the slit 5A such that the parts are independently displaceable, in the second embodiment, each portion 7a of the contact module 5, which is brought into contact with an associated one of the pads, is divided into two parts by a cut 205A such that the parts are independently displaceable. This division forms two contact points 207b and 207b in each portion 7a for contact with the pad. It should be noted that in the portion 7a divided by the cut 205A, surfaces of the elastic body 106 are displaced in sliding contact with each other.

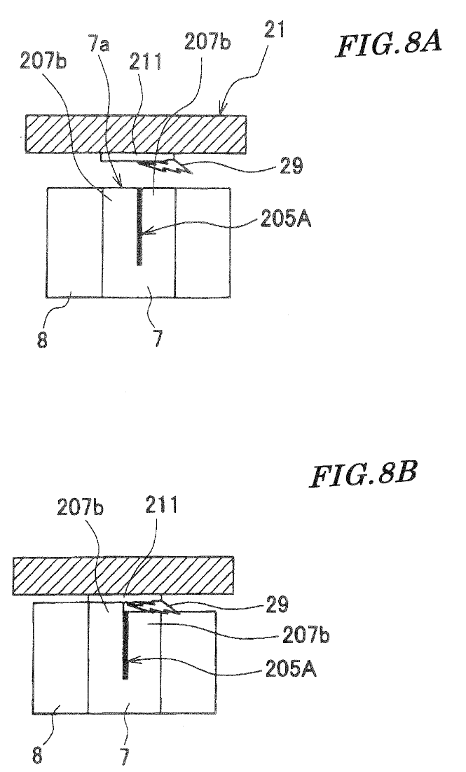

When foreign matter 29, such as dust, is attached to one of the pads 211 of the IC package 21, as shown in FIG. 8A, and the IC package 21 with the foreign matter 29 attached to the pad 211 thereof is pressed against a contact module 205 of the connector according to the second embodiment, as shown in FIG. 8B, similarly to the first embodiment, one of the two contact points 207b and 207b configured to be independently displaceable is largely pushed down by the foreign matter 29 attached to part of the pad 211, but the other contact point 207b is pushed down by the pad 211 substantially by a predetermined amount without being adversely affected by the motion of the one contact point 207b, for being brought into contact with the pad 211 substantially at a predetermined pressure. As a result, the state is ensured in which the conductive film 7 and the pad 211 are in stable contact with each other.

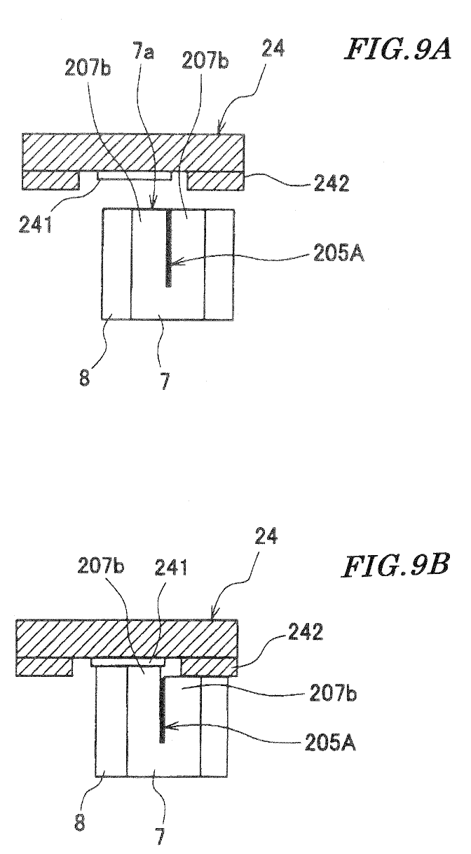

When the IC package 24 having the resist 242 formed in the vicinity of the pad 241 thereof is not normally positioned, as shown in FIG. 9A, and the IC package 24 is pressed against the contact module 205 in the state in which the IC package 24 is not normally positioned, as shown in FIG. 9B, one of the two contact points 207b and 207b which is configured to be independently displaceable is brought into abutment with the resist 242 and is largely pushed down by the resist 242, but the other contact point 207b is pushed down by the pad 241 substantially by a predetermined amount without being adversely affected by the motion of the one contact point 207b, for being brought into contact with the pad 241 substantially at a predetermined pressure. As a result, the state is ensured in which the conductive film 7 and the pad 241 are in stable contact with each other.

According to the second embodiment, it is possible to obtain the same advantageous effects as provided by the first embodiment, and machining of the divided portions of the portions 7a, which are brought into contract with the pad, can be performed more easily.

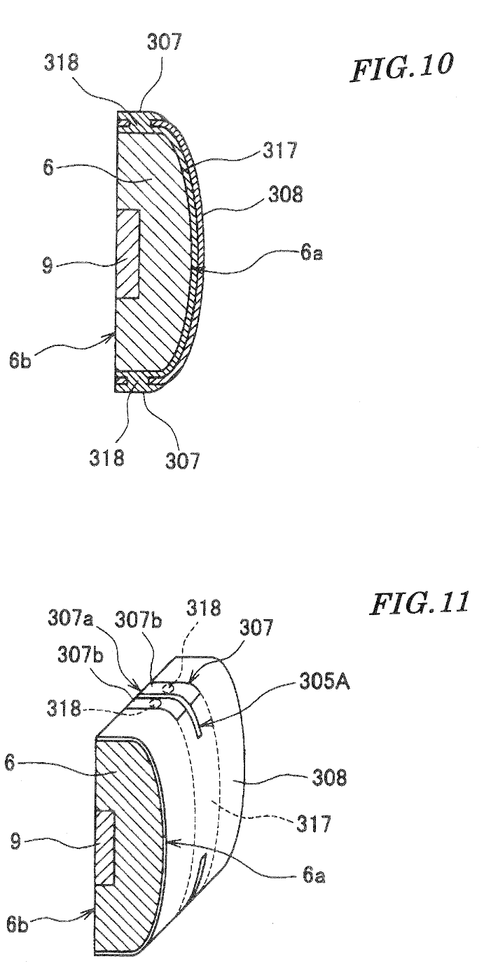

Now, a connector according to a third embodiment of the present invention will be described with reference to FIGS. 10 to 13B. Component parts identical to those of the connector according to the first embodiment are designated by identical reference numerals, and detailed description thereof is omitted, while only main component parts different in construction from those of the first embodiment will be described hereinafter.

Although in the first embodiment, the conductive films 7 are formed only on one surface of the film 8, in the third embodiment, first conductive films 307 having a rectangular shape are formed at equally spaced intervals on upper and lower edges of one surface of a film 308, respectively, and second conductive films 317 are formed on the other surface of the film 308 in a manner associated with the first conductive films 307. The first conductive films 307 and the second conductive films 317 are electrically connected to each other via a via 318. The first conductive films 307 may have any shape including a circular shape.

The film 308 is bonded to the elastic body 6 such that the first conductive films 307 are arranged on a front surface side. The first conductive films 307 form portions 307a which are brought into contact with the pads of the IC package.

Each portion 307a which is brought into contact with an associated one of the pads of the IC package is divided into two parts by a slit 305A such that the parts are independently displaceable, whereby two contact points 307b and 307b are formed.

The third embodiment is distinguished from the first embodiment in that the slits 305A are formed only in the first conductive films 307 and the second conductive films 317 and not formed in the elastic body 6.

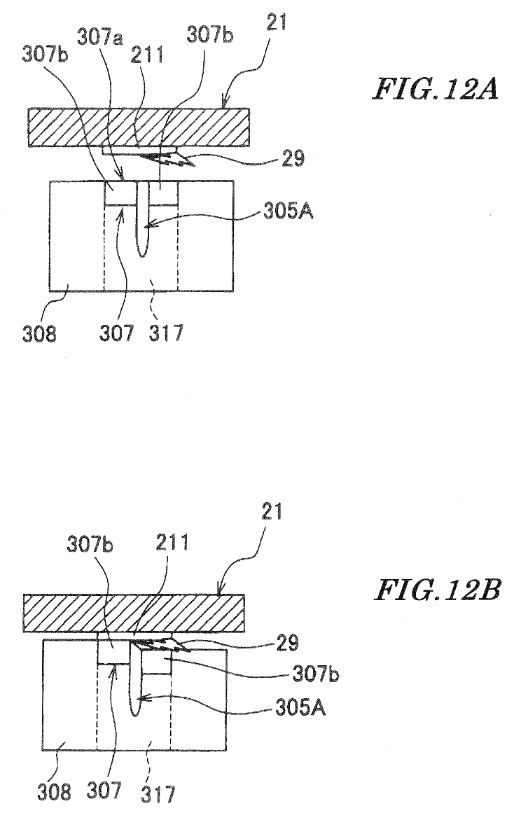

When foreign matter 29, such as dust, is attached to one of the pads 211 of the IC package 21, as shown in FIG. 12A, and the IC package 21 with the foreign matter 29 attached to the pad 211 thereof is pressed against a contact module 305 of the connector according to the third embodiment, as shown in FIG. 12B, similarly to the first embodiment, one of the two contact points 307b and 307b configured to be independently displaceable is largely pushed down by the foreign matter 29 attached to part of the pad 211, but the other contact point 307b is pushed down by the pad 211 substantially by a predetermined amount without being adversely affected by the motion of the one contact point 307b, for being brought into contact with the pad 211 substantially at a predetermined pressure. As a result, a state is ensured in which the conductive film 307 and the pad 211 are in stable contact with each other.

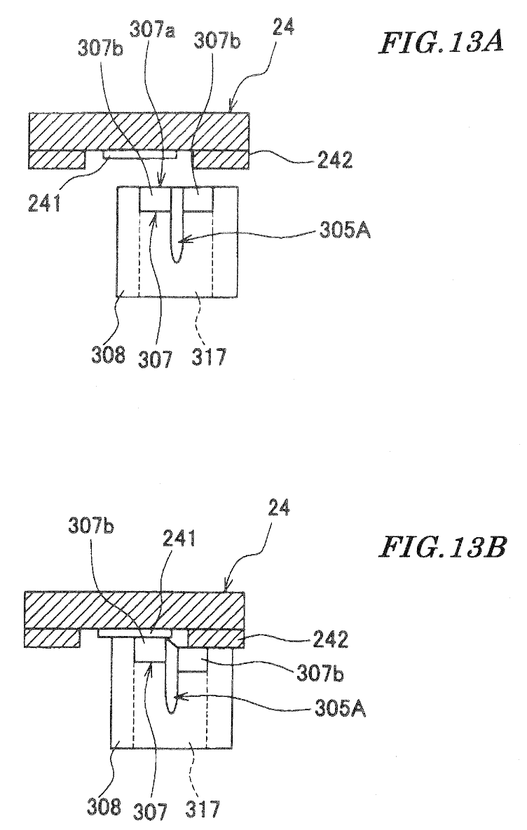

When the IC package 24 having the resist 242 formed in the vicinity of the pad 241 thereof is not normally positioned, as shown in FIG. 13A, and the IC package 24 is pressed against the contact module 305 in the state in which the IC package 24 is not normally positioned, as shown in FIG. 13B, one of the two contact points 307b and 307b configured to be independently displaceable is brought into abutment with the resist 242 and is largely pushed down by the resist 242, but the other contact point 307b is pushed down by the pad 241 substantially by a predetermined amount without being adversely affected by the motion of the one contact point 307b, for being brought into contact with the pad 241 substantially at a predetermined pressure. As a result, the state is ensured in which the conductive film 307 and the pad 241 are in stable contact with each other.

According to the third embodiment, it is possible to obtain the same advantageous effects as provided by the first embodiment, and the second conductive films 317 are not exposed, so that there is little fear of occurrence of a short circuit between the contact modules 305, whereby it is possible to arrange the contact modules 305 on the frame 3 (see FIG. 1) with high density.

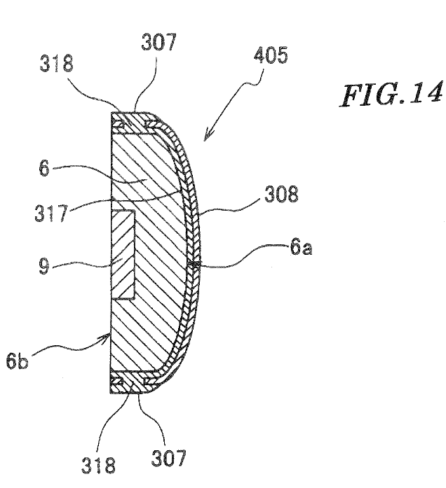

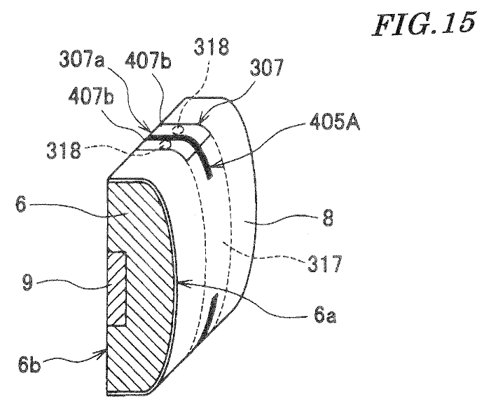

Now, a connector according to a fourth embodiment of the present invention will be described with reference to FIGS. 14 to 17B. Component parts identical to those of the connector according to the third embodiment are designated by identical reference numerals, and detailed description thereof is omitted, while only main component parts different in construction from those of the third embodiment will be described hereinafter.

Although in the third embodiment, each portion 307a of the contact module 305, which is brought into contact with an associated one of the pads of the IC package, is divided into two parts by the slit 305A such that the parts are independently displaceable, in the fourth embodiment, each portion 307a of the contact module 405, which is brought into contact with an associated one of the pads of the IC package, is divided into two parts by a cut 405A such that the parts are independently displaceable. This division forms two contact points 407b and 407b in each portion 307a which is brought into contact with the pad. In this embodiment as well, the slits are formed only in the conductive films.

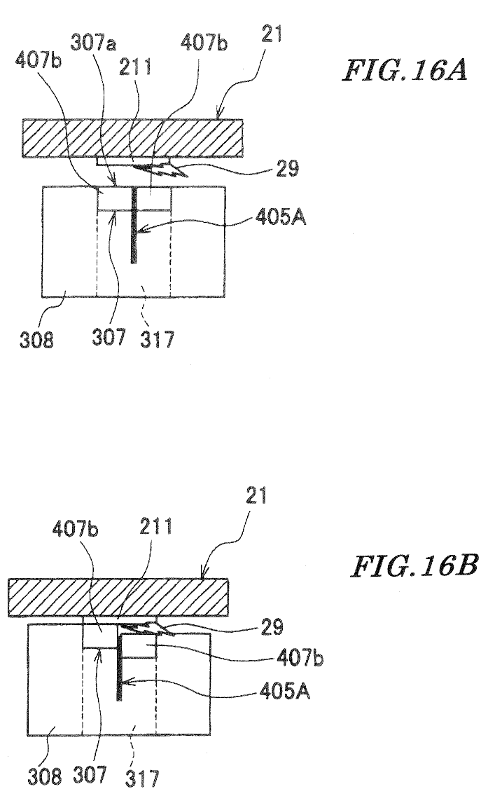

When foreign matter 29, such as dust, is attached to one of the pads 211 of the IC package 21, as shown in FIG. 16A, and the IC package 21 with the foreign matter 29 attached to the pad 211 thereof is pressed against the contact module 405 of the connector according to the fourth embodiment, as shown in FIG. 16B, similarly to the third embodiment, one of the two contact points 407b and 407b configured to be independently displaceable is largely pushed down by the foreign matter 29 attached to part of the pad 211, but the other contact point 407b is pushed down by the pad 211 substantially by a predetermined amount without being adversely affected by the motion of the one contact point 407b, for being brought into contact with the pad 211 substantially at a predetermined pressure. As a result, the state is ensured in which the conductive film 307 and the pad 211 are in stable contact with each other.

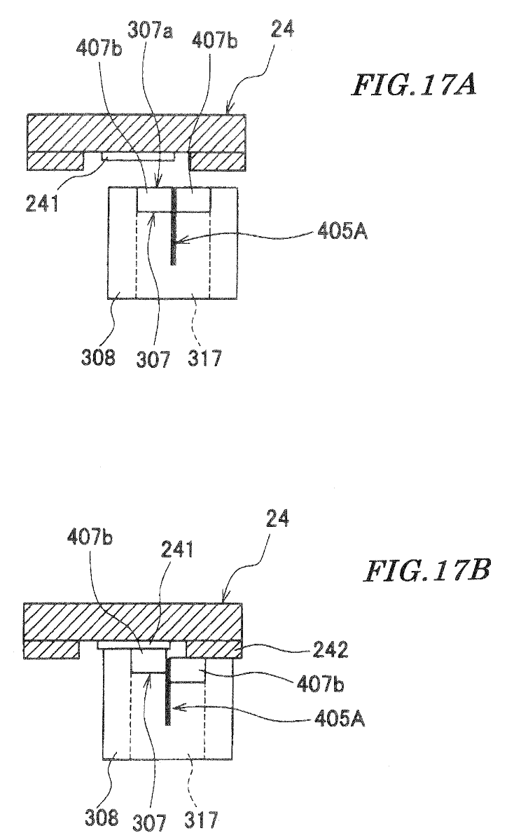

When the IC package 24 having the resist 242 formed in the vicinity of the pad 241 thereof is not normally positioned, as shown in FIG. 17A, and the IC package 24 is pressed against the contact module 305 in the state in which the IC package 24 is not normally positioned, as shown in FIG. 17B, one of the two contact points 407b and 407b configured to be independently displaceable is brought into abutment with the resist 242 and is largely pushed down by the resist 242, but the other contact point 407b is pushed down by the pad 241 substantially by a predetermined amount without being adversely affected by the motion of the one contact point 407b, for being brought into contact with the pad 241 substantially at a predetermined pressure. As a result, the state is ensured in which the conductive film 307 and the pad 241 are in stable contact with each other.

According to the fourth embodiment, it is possible to obtain the same advantageous effects as provided by the third embodiment, and each portion 307a, which is brought into contact with an associated one of the pads of the IC package, is divided into two parts by the cut 405A. This makes it possible to divide the portion 307a more easily.

It should be noted that in the above-described first and second embodiments, the slits 5A and the cuts 205A are formed in the conductive films 307 and the elastic body 6, the slits 5A and the cuts 205A may be formed in portions of the film 8, having no conductive films formed thereon. Further, similarly to the third and fourth embodiments, contact modules may be employed which have the slits and the cuts formed only in the conductive films.

Although in the above-described third and fourth embodiments, the slits 305A or the cuts 504A are formed only in the conductive films 307 and 317, if the slits 305A or the cuts 504A are also formed in the elastic body 106, it is possible to enhance independence of the contact points 307b and 407b, similarly to the first and second embodiments.

Further, if the slits 305A or the cuts 504A are also formed in the portions of the film 8, having no conductive films formed thereon, it is possible to further enhance independence (independence in displacement or deformation) of the contact points 307b and 407b.

It is further understood by those skilled in the art that the foregoing are the preferred embodiments of the present invention, and that various changes and modification may be made thereto without departing from the spirit and scope thereof.

What is claimed is:

1. A connector comprising:
an elastic body;
a conductive film formed on said elastic body, for electrically connecting respective terminals of two objects to be connected which are arranged on opposite sides of said elastic body; and
a dividing portion for dividing a contact portion of the conductive film into a plurality of parts such that said parts are independently displaceable, said contact portion being brought into contact with an associated one of said terminals of said two objects to be connected.

2. A connector as claimed in claim 1, wherein a film is disposed between said elastic body and said conductive film.

3. A connector as claimed in claim 1, wherein a portion of said conductive film except for said contact portion brought into contact with said associated one of said terminals of said two objects to be connected is covered with a film.

4. A connector as claimed in claim 2, wherein said dividing portion is a slit formed in said conductive film and said film.

5. A connector as claimed in claim 3, wherein said dividing portion is a slit formed in said conductive film and said film.

6. A connector as claimed in claim 2, wherein said dividing portion is a slit formed in said conductive film, said film, and said elastic body.

7. A connector as claimed in claim 3, wherein said dividing portion is a slit formed in said conductive film, said film, and said elastic body.

8. A connector as claimed in claim 2, wherein said dividing portion is a cut formed in said conductive film and said film.

9. A connector as claimed in claim 3, wherein said dividing portion is a cut formed in said conductive film and said film.

10. A connector as claimed in claim 2, wherein said dividing portion is a cut formed in said conductive film, said film. and said elastic body.

11. A connector as claimed in claim 3, wherein said dividing portion is a cut formed in said conductive film, said film. and said elastic body.

12. A connector as claimed in claim 1, wherein said conductive films are arranged at equally spaced intervals, and
wherein cutouts are formed in portions of said elastic body where said conductive films are not arranged.

13. A connector as claimed in claim 2, wherein said conductive films are arranged at equally spaced intervals, and
wherein cutouts are formed in portions of said elastic body where said conductive films are not arranged.

14. A connector as claimed in claim 3, wherein said conductive films are arranged at equally spaced intervals, and
wherein cutouts are formed in portions of said elastic body where said conductive films are not arranged.
